(19) United States
(12) Patent Application Publication
(10) Pub. No.: US 2021/0405969 A1
(43) Pub. Date: Dec. 30, 2021

(54) COMPUTER-READABLE RECORDING MEDIUM RECORDING ARITHMETIC PROCESSING PROGRAM, ARITHMETIC PROCESSING METHOD, AND ARITHMETIC PROCESSING DEVICE

(71) Applicant: FUJITSU LIMITED, Kawasaki-shi (JP)

(72) Inventor: Yusuke Nagasaka, Kawasaki (JP)

(73) Assignee: FUJITSU LIMITED, Kawasaki-shi (JP)

(21) Appl. No.: 17/216,736

(22) Filed: Mar. 30, 2021

(30) Foreign Application Priority Data
Jun. 30, 2020 (JP) 2020-112601

(51) Int. Cl. G06F 7/57; G06F 17/16

(52) U.S. Cl. CPC G06F 7/57; G06F 17/16

(57) ABSTRACT

A non-transitory computer-readable recording medium having stored therein an arithmetic processing program for causing an arithmetic processing device, which is configured to perform a vector operation on a plurality of pieces of data by using a hash table, to execute a process, the process includes: calculating a plurality of hash values from a plurality of keys that correspond to a plurality of pieces of operation-target data; detecting a conflict between the plurality of calculated hash values through execution of a conflict detection instruction; performing a vector operation on a piece of data whose hash value is conflict-free among the plurality of pieces of operation-target data; and reflecting a result of the operation in the hash table together with the key.

### CROSS-REFERENCE TO RELATED APPLICATION

This application is based upon and claims the benefit of priority of the prior Japanese Patent Application No. 2020-112601, filed on Jun. 30, 2020, the entire contents of which are incorporated herein by reference.

### FIELD

The embodiment discussed herein is related to a computer-readable recording medium, an arithmetic processing method, and an arithmetic processing device.

### BACKGROUND

The number of arithmetic processing devices is increasing which support a single instruction multiple data (SIMD) operation instruction for processing a plurality of pieces of data in parallel in response to a single instruction. For example, in a case where reduction operations are performed on data elements in a vector register, when a conflict between the data elements is detected, the operations are repeatedly performed on conflict-free data elements.

Related art is disclosed in Japanese National Publication of International Patent Application No. 2018-500556.

### SUMMARY

According to an aspect of the embodiments, a non-transitory computer-readable recording medium having stored therein an arithmetic processing program for causing an arithmetic processing device, which is configured to perform a vector operation on a plurality of pieces of data by using a hash table, to execute a process, the process includes: calculating a plurality of hash values from a plurality of keys that correspond to a plurality of pieces of operation-target data; detecting a conflict between the plurality of calculated hash values through execution of a conflict detection instruction; performing a vector operation on a piece of data whose hash value is conflict-free among the plurality of pieces of operation-target data; and reflecting a result of the operation in the hash table together with the key.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a server including a central processing unit (CPU) in one embodiment;

FIG. 2 is a functional block diagram illustrating an overview of processing functions performed by the CPU in FIG. 1;

FIG. 3 is an explanatory diagram illustrating an example of SIM′D operations performed by an arithmetic unit in FIG. 1;

FIG. 4 is an explanatory diagram illustrating an example of a conflict between pieces of data in a hash table in FIG. 1;

FIGS. 5A to 5F are an explanatory diagram illustrating an example of an operation performed by the CPU in FIG. 1;

FIGS. 6A to 6F is an explanatory diagram illustrating the operation continued from the operation in FIGS. 5A to 5F;

FIG. 7 is a flowchart illustrating an example of the operation of the CPU in FIG. 1; and

FIG. 8 is an explanatory diagram illustrating an example of effects of the embodiment.

### DESCRIPTION OF EMBODIMENTS

In a hash table that stores keys and value as pairs, a time taken for an insertion or a search is not dependent on an amount of data and is a fixed time. Thus, data may be accessed at a high speed independently of a data storage location or the like. On the other hand, for example, in a case where a storage destination of data used in relation to a SIMD operation instruction is a hash table, if hash values corresponding to data elements in a vector register conflict, contention of accesses to the hash table occurs. Consequently, parallel processing is not performed normally.

In one aspect, a vector operation using a hash table that has a risk of a conflict between hash values may be performed.

An embodiment will be described below using the drawings.

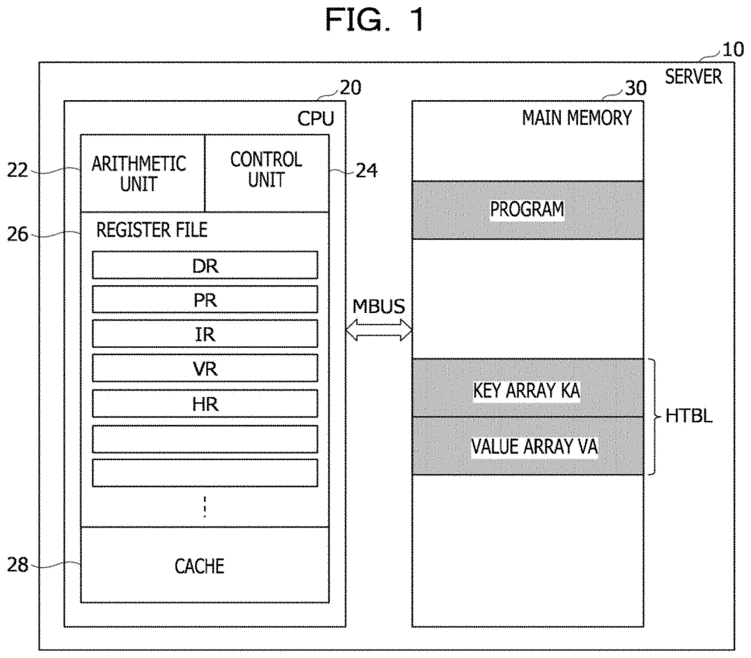

FIG. 1 illustrates an example of a server including a CPU in one embodiment. A server 10 illustrated in FIG. 1 includes a CPU 20 and a main memory 30 coupled to the CPU 20 through a memory bus MBUS. FIG. 1 illustrates a minimum number of elements used for implementing the embodiment. For example, the server 10 may include a plurality of CPUs 20, a hard disk drive, a chip-to-chip interconnect, a communication interface, a plurality of input/output interfaces, and so forth. The server 10 is an example of an information processing apparatus. The CPU 20 is an example of an arithmetic processing device.

The chip-to-chip interconnect mutually couples the plurality of CPUs 20 mounted in the server 10. The communication interface is coupled to, for example, a Peripheral Component Interconnect Express (PCIe) (registered trademark) bus. Each of the plurality of input/output interfaces is provided for coupling an input device, an output device, an external storage device, or the like. The external storage device coupled to the server 10 through the input/output interface is an example of a recording medium having stored therein an arithmetic processing program.

The CPU 20 includes an arithmetic unit 22, a control unit 24, a register file 26, and a cache 28. The arithmetic unit 22 includes a plurality of arithmetic elements that perform arithmetic operations. The CPU 20 is capable of executing a SIMD operation instruction using a vector register having a bit width of 512 bits. For example, the CPU 20 is capable of executing parallel arithmetic operations on 16 pieces of data having a bit width of 32 bits, 8 pieces of data having a bit width of 64 bits, or the like through SIMD operations according to a single SIMD operation instruction. For example, the CPU 20 supports, but not particularly limited to, AVX-512 that is an extension instruction set provided by Intel Corporation. The SIMD operation is an example of a vector operation.

The control unit 24 controls an operation of the arithmetic unit 22 that executes an arithmetic operation instruction. For example, the control unit 24 performs control for fetching data used in relation to an arithmetic operation instruction executed by the arithmetic unit 22 from any vector register of the register file 26 and storing an operation result in any vector register of the register file 26.

The register file 26 includes a plurality of vector registers that have a bit width of 512 bits and hold data or the like to be used in arithmetic operations. The bit width of each of the vector registers is not limited to 512 bits, and may be an nth power of 2 bits (where n is an integer of 2 or greater) such as 256 bits or 1024 bits. Five registers in the register file 26 are used as control registers DR, PR, IR, VR, and HR.

The control registers DR, PR, IR, VR, and HR are used for controlling SIMD operations performed using a hash table HTBL allocated in the main memory 30. The control registers DR, PR, IR, VR, and HR may be provided separately from the register file 26 as long as the control registers DR, PR, IR, VR, and HR are accessible by the CPU 20. The hash table HTBL may be allocated in a memory different from the main memory 30.

The control register DR is a yet-to-be-processed element management register that holds information indicating completion/incompletion of arithmetic processing on each of a plurality of data elements in the vector register. The control register PR is a processing target management register that holds information indicating whether or not each of the plurality of data elements in the vector register is a target of an arithmetic operation.

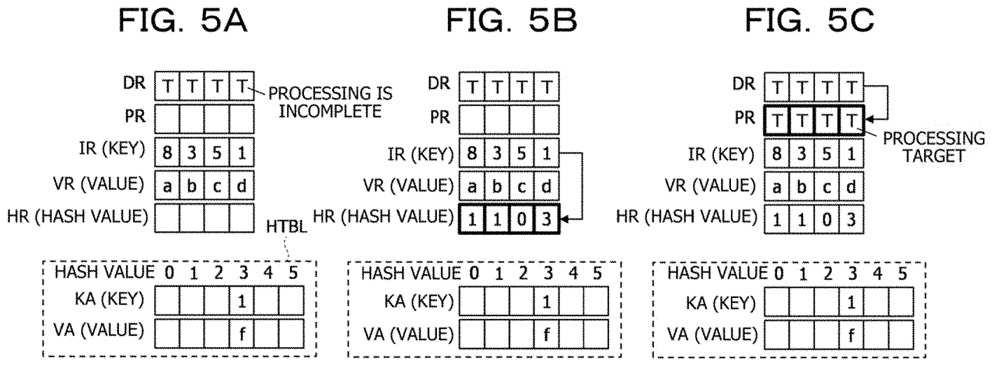

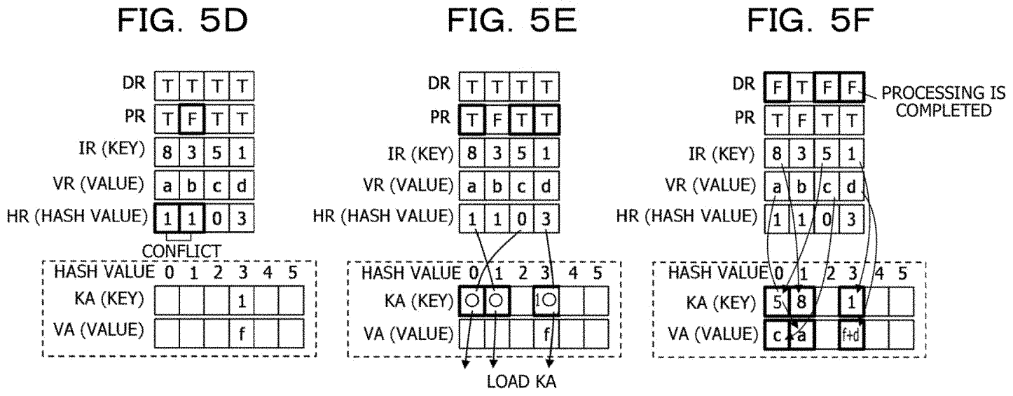

The control register IR is an index register that holds a key corresponding to each of the plurality of data elements in the vector register. The control register VR is a value register that holds the plurality of data elements (values) in the vector register. The control register HR is a hash register that holds a hash value obtained by inputting each key held in the control register IR to a hash function, in association with a corresponding one of the plurality of data elements in the vector register. A concrete usage example of the control registers DR, PR, IR, VR, and HR will be described in FIGS. 5A to 5F and subsequent figures. Hereinafter, the control registers DR, PR, IR, VR, and HR are also referred to as a DR register, a PR register, an IR register, a VR register, and an HR register, respectively.

The cache 28 stores at least one of part of data and some of instructions stored in the main memory 30. The main memory 30 has an area for storing programs such as an arithmetic processing program and an area in which the hash table HTBL is allocated. The hash table HTBL has a key array KA for storing keys and a value array VA for storing values.

For example, the hash table HTBL is used for an application in which handling of data frequently occurs, such as an application for operating a database. The hash table HTBL is used generally for applications that use dict (dictionary) in Python or std::map implemented in the C++ standard library. The hash table HTBL is used in processing in a programming language, such as management of an object in an object-oriented language or management of a name space. The hash table HTBL in this embodiment may be used for applications of this type and in processing of this type in a programming language.

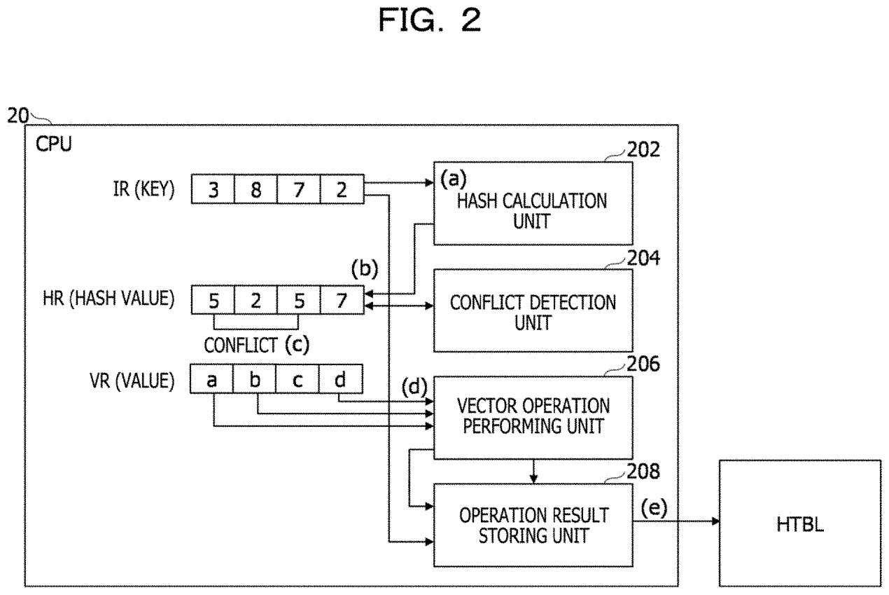

FIG. 2 illustrates an overview of processing functions performed by the CPU 20 in FIG. 1. The processing functions illustrated in FIG. 2 are implemented as a result of the CPU 20 executing an arithmetic processing program and causing the arithmetic unit 22, the register file 26, and so forth in FIG. 1 to operate. For example, FIG. 2 illustrates an example of an arithmetic processing method implemented based on the arithmetic processing program executed by the CPU 20.

The CPU 20 includes a hash calculation unit 202, a conflict detection unit 204, a vector operation performing unit 206, and an operation result storing unit 208. For example, the hash calculation unit 202, the conflict detection unit 204, the vector operation performing unit 206, and the operation result storing unit 208 are implemented as a result of the arithmetic elements mounted in the CPU 20 being caused to operate by the arithmetic processing program executed by the CPU 20. To make the description easily understandable, FIG. 2 illustrates an example in which up to four SIM′D operations are performed using four data elements.

The hash calculation unit 202 respectively calculates four hash values (5, 2, 5, 7) from four keys (3, 8, 7, 2) stored in the IR register in association with a plurality of operation-target values (a, b, c, d) stored in the VR register ((a) in FIG. 2). The hash calculation unit 202 stores the calculated hash values in the HR register ((b) in FIG. 2). The conflict detection unit 204 executes a conflict detection instruction and detects a conflict between the hash values stored in the HR register ((c) in FIG. 2). In this example, the conflict detection unit 204 detects a conflict between the hash values (=5) corresponding to the first and third elements (keys or values) from the left.

The vector operation performing unit 206 performs SIMS operations on three values a, b, and d whose hash values are conflict-free among the four values stored in the VR register ((d) in FIG. 2). The operation result storing unit 208 reflects arithmetic operation results of the SIMD operations performed by the vector operation performing unit 206 in the hash table HTBL together with the keys ((e) in FIG. 2).

Subsequently, the conflict detection unit 204 detects a conflict between the hash values stored in the HR register in association with the values on which the SIMD operation is not performed yet. In this example, since the value on which the SIMD operation is not performed yet is the third data element “c” from the left alone, the conflict detection unit 204 does not detect the occurrence of a conflict. The vector operation performing unit 206 performs a SIMD operation on the value “c”. The operation result storing unit 208 reflects an operation result for the value “c” in the hash table HTBL together with the key.

In this embodiment, the conflict detection processing, the SIMD operations on the conflict-free data elements, and reflection of the operation results in the hash table HTBL are repeatedly performed until a conflict between the hash values no longer occurs. The SIMD operation may be performed by using the value stored in the VR register and the value held in the hash table HTBL.

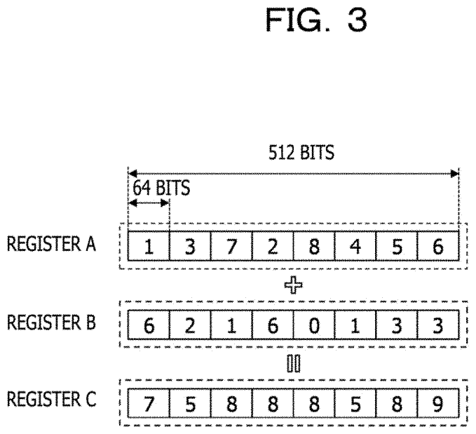

FIG. 3 illustrates an example of SIMD operations performed by the arithmetic unit 22 in FIG. 1. In the example illustrated in FIG. 3, eight 64-bit data elements are loaded to a vector register A, and eight 64-bit data elements are loaded to a vector register B. A SIMD operation instruction for adding the corresponding data elements in the vector registers A and B having a bit width of 512 bits in parallel is executed. The addition results are stored in a register C. Thus, the arithmetic operation efficiency may be increased by approximately eight times, compared with the case where pairs of 64-bit data elements are added one by one. In response to a SIMD operation instruction, 16 32-bit data elements loaded to the vector register A and 16 32-bit data elements loaded to the vector register B may be respectively added.

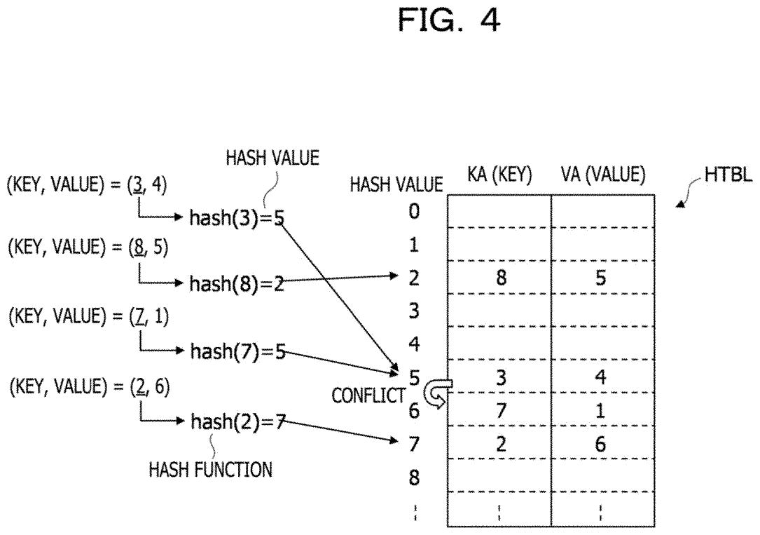

FIG. 4 illustrates an example of a conflict between pieces of data in the hash table HTBL in FIG. 1. In the example illustrated in FIG. 4, pieces of data that are (key, value) pairs of (3, 4), (8, 5), (7, 1), and (2, 6) are stored in the hash table HTBL. For example, the CPU 20 substitutes the key of each pair to a hash function “hash” and calculates a hash value. The CPU 20 stores the pair of the key and the value in an area indicated by the hash value in the hash table HTBL.

For example, in a case where the number of areas (table size) of the hash table HTBL is less than the number of key-value pairs storable in the hash table HTBL, hash values obtained from keys having values different from each other may be the same value (conflict). In the example illustrated in FIG. 4, both of a hash value for the key=“3” and a hash value for the key=“7” are “5”, and a conflict occurs. For example, in a linear probing method that is one of open addressing methods, in a case where two hash values conflict with each other, the conflict is resolved by storing the key and the value that correspond to one of the hash values in an area indicated by a value obtained by incrementing the one of the hash values by “+1”.

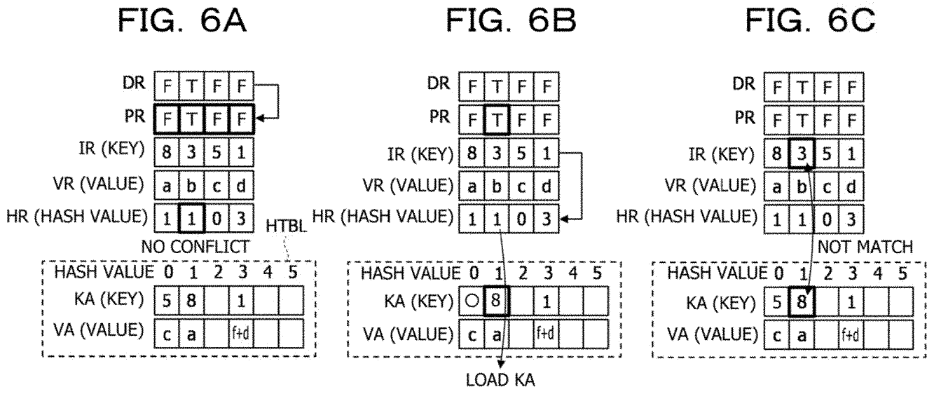

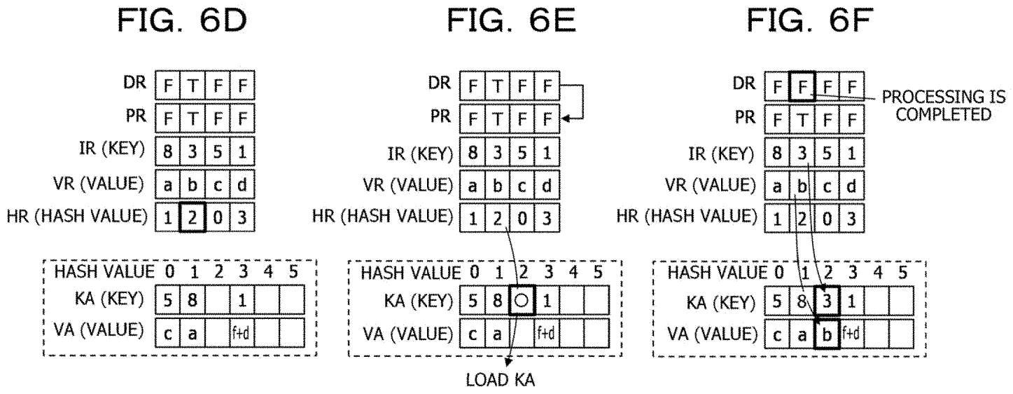

FIGS. 5 and 6 illustrate an example of an operation performed by the CPU 20 in FIG. 1. FIGS. 5 and 6 illustrate an example of the arithmetic processing method implemented based on the arithmetic processing program executed by the CPU 20. To make the description easily understandable, FIGS. 5 and 6 illustrate an example in which each vector register includes four elements and a SIMD operation instruction for four data elements is executed.

In an initial state illustrated in FIG. 5A, a flag “true (T)” indicating that processing is incomplete is stored for each element in the DR register. Four keys “8”, “3”, “5”, and “1” are stored in the IR register. Four values “a”, “b”, “c”, and “d” are stored in the VR register. The key-value pair (1, f) is held in an area for a hash value “3” in the hash table HTBL in the main memory 30.

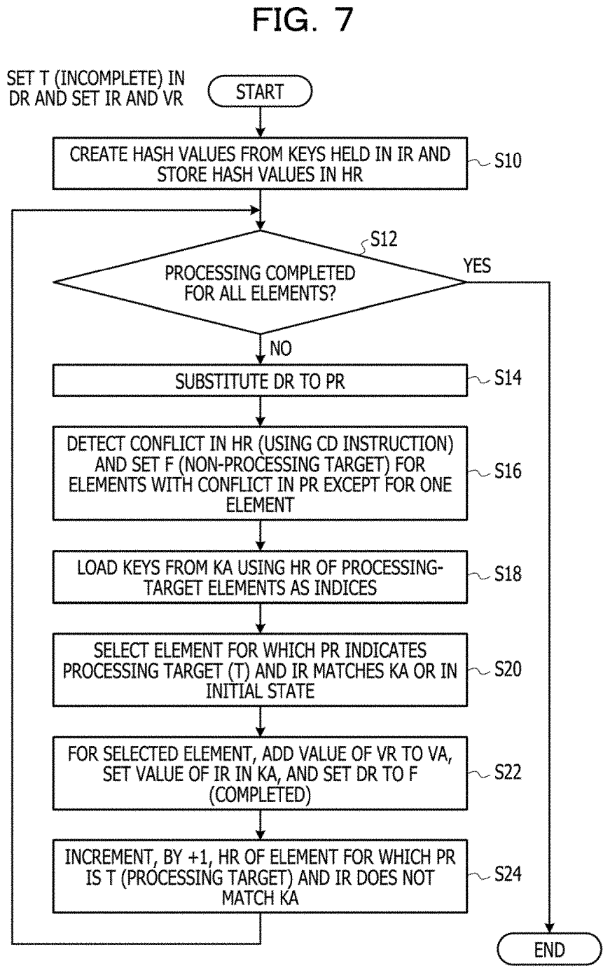

In FIG. 5B to FIG. 6C, SIMD operation processing (for example, addition) is performed in which arithmetic operations are performed on the four values stored in the VR register and the values held in the corresponding areas of the hash table HTBL and results of the arithmetic operations are stored in the hash table HTBL. By providing the IR register, the VR register, and the HR register that respectively store the keys, the values, and the hash values, resetting of the key and the value and recalculation of the hash value may be suppressed even in a case where the arithmetic processing is repeated as described in FIG. 7. Therefore, an increase in cost for executing the SIMD operation instruction using the hash table HTBL may be suppressed.

In FIG. 5B, the CPU 20 calculates a hash value from each key held in the IR register, and stores the calculated hash value in the HR register. In this example, the hash value “1” obtained from the key “8” and the hash value “1” obtained from the key “3” conflict (duplicate) with each other. In FIG. 5C, the CPU 20 copies the flags (all “T” in this example) held in the DR register to the PR register. In the PR register, a flag “true (T)” indicates a processing-target element, and a flag “false (F)” indicates a non-processing-target element. The flags T and F set in the PR register are an example of a processing-target flag for identifying a value whose hash value is conflict-free. The flags T and F may be represented by logical values 1 and 0, respectively. In such a case, the logical value 1 indicates the processing-target element.

In FIG. 5D, the CPU 20 executes a conflict detection (CD) instruction for detecting a conflict between the hash values held in the HR register for the processing-target elements. The CD instruction is an example of a conflict detection instruction. The CPU 20 detects a conflict between the hash values “1” of the first and second elements from the left in the HR register. The CPU 20 selects one element (in this example, the first element) from among the elements for which a conflict has occurred and selects elements for which a conflict has not occurred. The CPU 20 sets the element corresponding to the unselected element in the PR register to the flag F (non-processing target).

In FIG. 5E, the CPU 20 refers to the PR register, and loads, for the processing-target elements (the flag T), the keys from the areas of the key array KA of the hash table HTBL by using, as indices, the hash values held in the HR register. When a key is held in the area of the key array KA, the held key is loaded. When the area of the key array KA is empty, empty key information is loaded. The information loaded from the hash table HTBL is stored in any of the vector registers of the register file 26 (not illustrated). The elements whose the hash values conflict with each other are excluded from the processing targets except for one of the elements in FIG. 5D. Thus, the keys may be loaded from the hash table HTBL without contention of accesses to the hash table HTBL.

In FIG. 5F, the CPU 20 selects, from among the processing-target elements, an element for which the key held in the IR register matches the key loaded from the hash table HTBL. The CPU 20 also selects, from among the processing-target elements, an element for which the empty key information is loaded from the hash table HTBL. In this example, all the processing-target elements are selected.

The CPU 20 executes a SIMD operation instruction for the values held in the VR register in association with the selected elements and the values held in the areas, corresponding to the hash values held in the HR register, of the value array VA of the hash table HTBL. In this example, the CPU 20 adds the value held in the VR register to the value held in the area of the value array VA of the hash table HTBL. By providing the DR register for identifying the processing-target elements (values), the processing-target values whose hash values are conflict-free may be easily extracted from the VR register, and even in a case where the arithmetic processing is repeated, the SIMD operation instructions may be sequentially executed.

The CPU 20 stores the key held in the IR register in association with the selected element in the area, corresponding to the hash value held in the HR register, of the key array KA of the hash table HTBL. The CPU 20 changes elements for which execution of the SIMD operation instruction is completed, among the elements with the flag T in the DR register, to the flag F indicating completion of the processing. The flags T and F set in the DR register are an example of a processing completion flag for identifying a value for which a SIMD operation instruction is already executed. The flags T and F may be represented by logical values 1 and 0, respectively. In such a case, the logical value 0 indicates completion of the processing (completion of the SIMD operation).

By excluding elements whose hash values conflict with each other from the processing targets except for one of the elements, contention of accesses to the hash table HTBL due to the conflict between the hash values may be suppressed. Thus, without contention of accesses to the hash table HTBL, a SIMD operation instruction may be executed and the operation results may be reflected in the hash table HTBL. As a result, SIMD operations may be performed without an error even in a case where the hash table HTBL that has a risk of a conflict between hash values is used. Since sequential instructions do not have to be executed instead of a SIMD operation instruction, the arithmetic operation efficiency may be improved, compared with a case where the sequential instructions are executed.

Since the flag T indicating incompletion of the processing is held in the DR register, the CPU 20 copies all the flags held in the DR register to the PR register in FIG. 6A. The CPU 20 executes a CD instruction for the HR register in relation to the processing-target elements. In this example, since the processing-target element (the flag T) is the second element from the left alone and no conflict between the hash values is detected, the CPU 20 selects the second element.

In FIG. 68, the CPU 20 refers to the PR register, and loads, for the processing-target element, namely, the second element from the left, a key “8” from the area of the key array KA of the hash table HTBL, by using, as an index, the hash value held in the HR register. In FIG. 6C, the CPU 20 selects an element for which the key held, for the second element from the left that is the processing target indicated by the flag T in the PR register, in the IR register matches the key loaded from the hash table HTBL. In this example, the key “3” held in the IR register does not match the key “8” loaded from the hash table HTBL.

Therefore, in FIG. 6D, the CPU 20 increments, by (“+1”), the hash value held in the HR register for the element whose keys do not match among the processing-target elements, so that the hash value is changed to “2”. By changing, among the hash values held in the HR register, the hash values that conflict with each other except for one of the hash values to conflict-free values, a SIMD operation instruction may be executed while a conflict between hash values is avoided in the second and subsequent processing.

In FIG. 6E, the CPU 20 copies all the flags held in the DR register to the PR register. The CPU 20 refers to the PR register, and loads, for the processing-target element (in this case, the second element from left), the key from the area of the key array KA of the hash table HTBL by using, as an index, the hash value held in the HR register.

In FIG. 6F, the CPU 20 selects, from among the processing-target elements indicated by the flag T in the PR register, an element (in this example, the second element from the left) for which the key held in the IR register matches the key loaded from the hash table HTBL. The CPU 20 stores the key held in the IR register in association with the selected element in the area, corresponding to the hash value held in the HR register, of the key array KA of the hash table HTBL.

The CPU 20 performs a SIMD operation (in this example, addition) on the value held in the VR register in association with the selected element and the value held in the area, corresponding to the hash value held in the HR register, of the value array VA of the hash table HTBL. Subsequently, the CPU 20 changes, among the elements for which the flag T is held in the DR register, the element on which the SIMD operation is already performed to the flag F indicating completion of the processing. The CPU 20 determines that execution of the SIMD operation instruction is completed based on the fact that all the elements in the DR register are changed to the flag F.

FIG. 7 illustrates an example of the operation of the CPU 20 in FIG. 1. FIG. 7 illustrates an example of the arithmetic processing program executed by the CPU 20 and illustrates an example of the arithmetic processing method implemented based on the arithmetic processing program. Before the process illustrated in FIG. 7 is started, the flag T indicating incompletion of the processing is stored in each element in the DR register, keys are stored in respective elements in the IR register, and values are stored in respective elements in the VR register.

In step S10, the CPU 20 calculates a hash value from each key held in the IR register, and stores the calculated hash value in the HR register. In step S12, the CPU 20 refers to the DR register. If the arithmetic processing on all the elements is completed, the CPU 20 ends the process illustrated in FIG. 7. If there is an element for which the arithmetic processing is incomplete, the CPU 20 performs step S14. If all the elements in the DR register are changed to the flag F, the CPU 20 determines that the arithmetic processing on all the elements is completed. By providing the DR register indicating completion/incompletion of processing, it may be easily determined whether or not the arithmetic processing on all the elements is completed with reference to the DR register even in a case where the arithmetic processing is repeated.

In step S14, the CPU 20 substitutes (copies) the flags held in the DR register to the PR register. In step S16, the CPU 20 detects, by using a CD instruction, whether or not there is a conflict between the hash values held in the HR register for the processing-target elements. Except for one of the elements whose hash values conflict with each other, the CPU 20 sets the elements in the PR register that correspond to the other elements to the flag F (non-processing target).

In step S18, the CPU 20 loads, for the processing-target elements, keys from the areas of the key array KA of the hash table HTBL by using, as indices, the hash values held in the HR register. In step S20, the CPU 20 selects an element for which the element in the PR register indicates the processing target (the flag T) and for which the key held in the IR register matches the key loaded from the hash table HTBL. The CPU 20 also selects an element for which the element in the PR register indicates the processing target (the flag T) and for which the empty key information is loaded from the hash table HTBL.

In step S22, the CPU 20 performs a SIMD operation. For example, the CPU 20 adds, for the element selected in step S20, the value held in the VR register to the value held in the corresponding area of the value array VA of the hash table HTBL. The CPU 20 stores the key held in the IR register in association with the selected element, in the corresponding area of the key array KA of the hash table HTBL. The CPU 20 changes, among the elements with the flag T in the DR register, the element for which the SIMD operation is already performed to the flag F indicating completion of the processing.

In step S24, the CPU 20 detects an element that s the processing-target element (the flag T) indicated in the PR register and for which the key held in the IR register does not match the key loaded from the hash table HTBL. The CPU 20 increments, by “+1”, the hash value held in the HR register in association with the element for which a key mismatch is detected, and returns the process to step S12. Subsequently, the processing of steps S14 to S24 is repeatedly performed until all the elements in the DR register are set to the flag F. By repeating the loop of steps S12 to S24, even in a case where the hash values conflict with each other, vector operations may be performed on all the operation-target elements in the vector register without the occurrence of contention of accesses to the hash table.

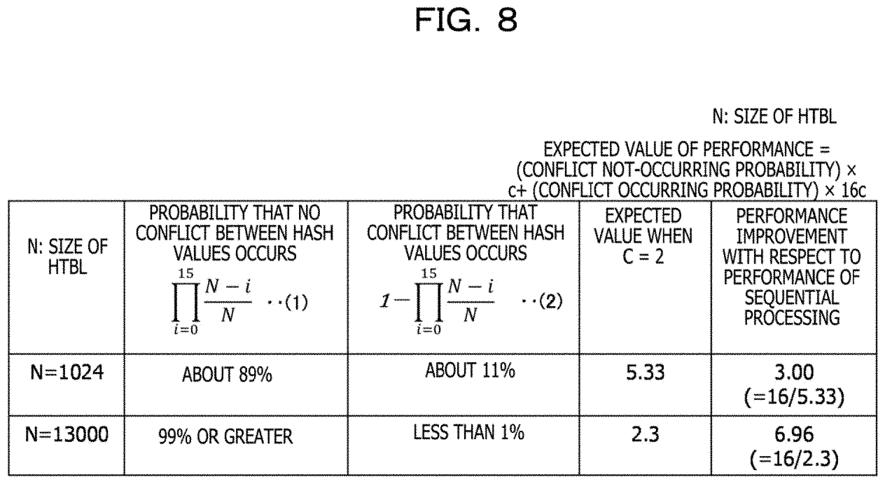

FIG. 8 illustrates an example of effects of the embodiment. For example, it is assumed that keys are 32-bit wide and that 16 elements are processed at one time in response to a SIMD operation instruction. It is also assumed that the cost of sequential processing per element is “1” and that the cost per iteration in the embodiment is “c.” One iteration is one loop of steps S12 to S24 in FIG. 7. It is assumed that the size of the hash table (the number of areas in which key-value pairs are stored) is “N” and that a hash value is uniformly determined in the entire hash table HTBL.

Under the above conditions, the probability that no conflict between hash values occurs is represented by expression (1) in FIG. 8, and is about 89% when N=1024 and is 99% or greater when N=13000. On the other hand, the probability that a conflict between hash values occurs is represented by expression (2) in FIG. 8, and is about 11% when N=1024 and is less than 1% when N=13000. Thus, when N is about 1000 or more, the probability of a conflict between hash values is not so high. When N is about 13000, the probability is almost negligible.

For example, in a case where the cost c per iteration is “2”, the expected value of performance is “5.33” when N=1024 and is “2.3” when N 13000. As a result, the performance in the embodiment is expected to be improved by three times when N=1024 and by about seven times when N 13000 with respect to the performance of the sequential processing. Since the estimate of the cost c=“2” per iteration is relatively high, the actual performance improvement is expected to be higher.

As described above, in the embodiment illustrated in FIGS. 1 to 8, a SIMD operation instruction may be executed and operation results may be reflected in the hash table HTBL without contention of accesses to the hash table HTBL. As a result, SIMD operations may be performed without an error even in a case where the hash table HTBL that has a risk of a conflict between hash values is used. Thus, since sequential instructions do not have to be executed instead of a SIMD operation instruction, the arithmetic operation efficiency may be improved, compared with a case where the sequential instructions are executed.

By repeating the loop of steps S12 to S24 illustrated in FIG. 7, even in a case where hash values conflict with each other, vector operations may be performed on all the operation-target elements in the vector register without the occurrence of contention of accesses to the hash table.

By providing the IR register, the VR register, and the HR register that respectively store the keys, the values, and the hash values, resetting of the key and the value and recalculation of the hash value may be suppressed even in a case where the arithmetic processing is repeated. Therefore, an increase in cost for executing the SIMD operation instruction using the hash table HTBL may be suppressed.

By providing the DR register for identifying the processing-target elements (values), the processing-target values whose hash values are conflict-free may be easily extracted from the VR register, and even in a case where the arithmetic processing is repeated, the SIMD operations may be sequentially performed. By providing the DR register indicating completion/incompletion of processing, it may be easily determined whether or not the arithmetic processing on all the elements is completed with reference to the DR register even in a case where the arithmetic processing is repeated. By changing, among the hash values held in the HR register, the hash values that conflict with each other except for one of the hash values to conflict-free values, SIMD operations may be performed while a conflict between hash values is avoided in the second and subsequent processing.

Features and advantages of the embodiment become apparent from the detailed description above. The scope of claims is intended to cover the features and advantages of the embodiment described above within a scope not departing from the spirit and scope of right of the claims. Any person having ordinary skill in the art may easily conceive every improvement and alteration. Accordingly, the scope of inventive embodiments is not intended to be limited to that described above and may rely on appropriate modifications and equivalents included in the scope disclosed in the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an arithmetic processing program for causing an arithmetic processing device, which is configured to perform a vector operation on a plurality of pieces of data by using a hash table, to execute a process, the process comprising:
calculating a plurality of hash values from a plurality of keys that correspond to a plurality of pieces of operation-target data;
detecting a conflict between the plurality of calculated hash values through execution of a conflict detection instruction;
performing a vector operation on a piece of data whose hash value is conflict-free among the plurality of pieces of operation-target data; and
reflecting a result of the operation in the hash table together with the key.

2. The non-transitory computer-readable recording medium according to claim 1, wherein
the detecting of conflicting hash values, the performing of the vector operation on the piece of data whose hash value is conflict-free, and the reflecting of the result of the operation and the key in the hash table are repeated until processing of all the pieces of operation-target data is completed.

3. The non-transitory computer-readable recording medium according to claim 1, wherein
the vector operation is performed by using a piece of operation-target data and a piece of data held in the hash table.

4. The non-transitory computer-readable recording medium according to claim 1, wherein
the plurality of pieces of operation-target data are stored in a first vector register,
the plurality of keys that correspond to the plurality of pieces of operation-target data are stored in a second vector register,
the plurality of hash values calculated from the plurality of keys held in the second vector register are stored in a third vector register,
the conflict detection instruction is executed for the plurality of hash values held in the third vector register, and
the vector operation is performed on a piece of data whose hash value is conflict-free among the plurality of pieces of operation-target data held in the first vector register.

5. The non-transitory compute readable recording medium according to claim 4, wherein
a processing target flag for identifying the piece of data whose hash value is conflict-free among the plurality of pieces of operation-target data held in the first vector register is set in a fourth vector register in accordance with an array of the plurality of pieces of operation-target data; and
the vector operation is performed on the piece of data held in the first vector register in association with an array in which the processing-target flag is set in the fourth vector register.

6. The non-transitory computer-readable recording medium according to claim 5, wherein
prior to the vector operation, processing of
setting, in a fifth vector register, a processing completion flag for identifying a piece of data on which the vector operation is already performed among the plurality of pieces of operation-target data held in the first vector register, and
setting the processing-target flag in the array of the fourth vector register that corresponds to an array in which the processing completion flag is not set
is performed.

7. The non-transitory computer-readable recording medium according to claim 4, wherein
except for one of the hash values for which the conflict is detected among the plurality of hash values held in the third vector register, the hash value for which the conflict is detected is changed to a conflict-free value.

8. An arithmetic processing method comprising:
performing, by a computer, a vector operation on a plurality of pieces of data by using a hash table;
calculating a plurality of hash values from a plurality of keys that correspond to a plurality of pieces of operation-target data;
detecting a conflict between the plurality of calculated hash values through execution of a conflict detection instruction;
performing a vector operation on a piece of data whose hash value is conflict-free among the plurality of pieces of operation-target data; and
reflecting a result of the operation in the hash table together with the key.

9. An arithmetic processing device comprising:
a memory; and
a processor coupled to the memory and configured to:
perform a vector operation on a plurality of pieces of data by using a hash table;
calculate a plurality of hash values from a plurality of keys that correspond to a plurality of pieces of operation-target data;
detect a conflict between the plurality of calculated hash values through execution of a conflict detection instruction;
perform a vector operation on a piece of data whose hash value is conflict-free among the plurality of pieces of operation-target data; and
reflect a result of the operation in the hash table together with the key.
